(19) United States
(12) Patent Application Publication
(10) Pub. No.: US 2018/0186072 A1
(43) Pub. Date: Jul. 5, 2018

(54) METHOD AND SYSTEM FOR MANUFACTURING AN ARTICLE

(71) Applicant: ABB Schweiz AG, Baden (CH)

(72) Inventors: Gregory F. Rossano, Enfield, CT (US); George Q. Zhang, Windsor, CT (US); David Alan Bourne, Acme, PA (US)

(21) Appl. No.: 15/859,433

(22) Filed: Dec. 30, 2017

Related U.S. Application Data
(60) Provisional application No. 62/441,225, filed on Dec. 31, 2016.

(51) Int. Cl. B29C 64/209; B33Y 10/00; B33Y 30/00; B29C 64/10

(52) U.S. Cl. CPC B29C 64/209; B29C 64/10; B33Y 30/00; B33Y 10/00

(57) ABSTRACT

A method for manufacturing an article includes initiating additive manufacturing of the article, and forming a portion of the article using an additive manufacturing process on an additive manufacturing system. The additive manufacturing process may be paused, and a procedure may be performed on the article. The additive manufacturing process may be resumed and the article completed. A system for performing additive manufacturing of an article includes a printhead, and drive modules operative to generate translational motion between the printhead and a build surface in more than one axis. A rotational joint is operative to rotate the printhead about at least one axis.

### TECHNICAL FIELD

The present application relates generally to manufacturing and more particularly, but not exclusively, to systems and methods for manufacturing an article with an additive manufacturing process.

### BACKGROUND

Methods and systems for performing additive manufacturing processes remain an area of interest. Some existing methods and systems have various shortcomings, drawbacks and disadvantages relative to certain applications. For example, in some methods and systems, procedures performed on an article prior to completion of additive manufacturing may adversely affect the quality of the additively manufactured article. Accordingly, there remains a need for further contributions in this area of technology.

### SUMMARY

One embodiment of the present invention is a unique method for manufacturing an article. Another embodiment is unique system for performing additive manufacturing of an article on a build surface. Other embodiments include apparatuses, systems, devices, hardware, methods, and combinations for additive manufacturing of various types. Further embodiments, forms, features, aspects, benefits, and advantages of the present application shall become apparent from the description and figures provided herewith.

### BRIEF DESCRIPTION OF THE FIGURES

The description herein makes reference to the accompanying drawings wherein like reference numerals refer to like parts throughout the several views, and wherein:

FIG. 1 schematically illustrates some aspects of a non-limiting example of a system for performing additive manufacturing in accordance with an embodiment of the present invention.

FIG. 2 schematically illustrates some aspects of a non-limiting example of a flowchart depicting a method for manufacturing an article in accordance with an embodiment of the present invention.

FIG. 3 schematically illustrates some aspects of a non-limiting example of a portion of an article manufactured by an additive manufacturing process into which a premade part is assembled in accordance with an embodiment of the present invention.

FIGS. 4A and 4B schematically illustrate some aspects of a non-limiting example of a respective schematic plan view and side view of a portion of a system for performing additive manufacturing with a repositioning feature in the form of a kinetic ball mount.

FIGS. 5A and 5B schematically illustrate some aspects of a non-limiting example of a respective schematic plan view and side view of a portion of a system for performing additive manufacturing with a repositioning feature in the form of a corner block.

FIGS. 6A and 6B schematically illustrate some aspects of a non-limiting example of a respective schematic plan view and side view of a portion of a system for performing additive manufacturing with repositioning features in the form of pins and mating openings.

FIG. 7 schematically illustrates some aspects of a non-limiting example of a portion of an article manufactured by an additive manufacturing process into which a premade part is assembled, and in which a system for performing additive manufacturing 3-D prints around the premade part, in accordance with an embodiment of the present invention.

FIG. 8 schematically illustrates some aspects of a non-limiting example of a portion of an article manufactured by an additive manufacturing process into which a premade part is encapsulated within a 3-D printed article in accordance with an embodiment of the present invention.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

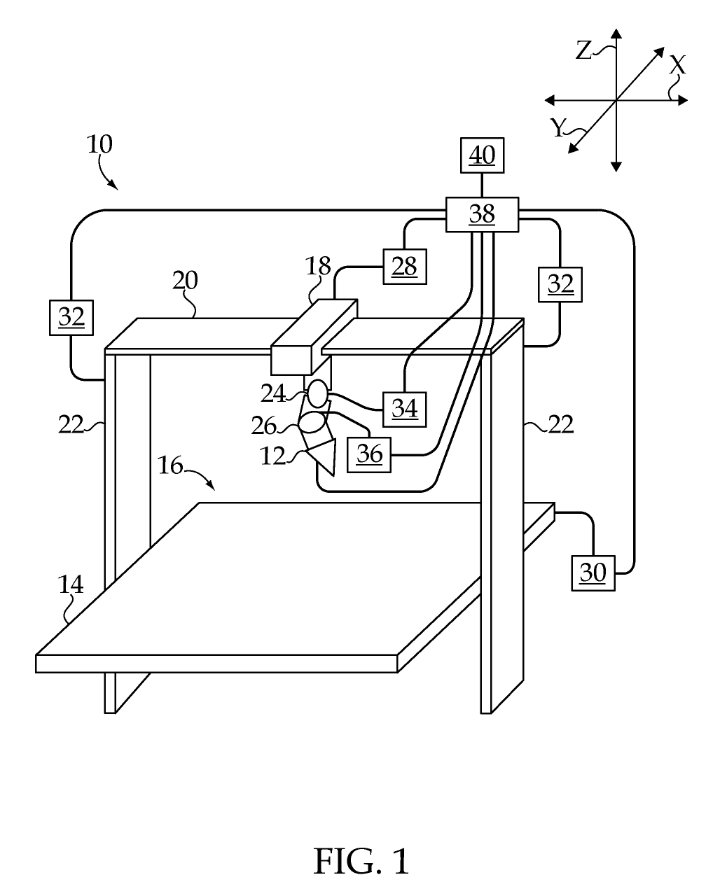

Referring to FIG. 1, some aspects of a non-limiting example of a system 10 for performing additive manufacturing in accordance with an embodiment of the present invention is schematically illustrated. System 10 includes printhead 12 and a bed 14. In one form, bed 14 forms a build surface 16 upon which an article is built in a layer-by-layer fashion by system 10 using an additive manufacturing process, e.g., 3-D printing. In other embodiments, build surface 16 may be spaced apart from bed 14, e.g., by a positioning feature as described in some embodiments herein. System 10 is operative to generate relative translational motion between printhead 12 and build surface 16 (bed 14 in the embodiment of FIG. 1) in three (3) mutually orthogonal axes, e.g., axes X, Y and Z. In one form, e.g., in the illustrated embodiment, system 10 is operative to generate the relative translational motion by translating printhead 12 bidirectionally along the X axis, and by translating bed 14 or another build surface 16 bidirectionally along each of the Y and Z axes. In other embodiments, other schemes may be employed to achieve relative translational motion between printhead 12 and bed 14 or another build surface 16.

In one form, additive manufacturing or 3-D printing system 10 and printhead 12 is a material extrusion system, e.g., a fused deposition modeling system, e.g., in which a build material filament and in some embodiments also a support material filament, is melted and extruded onto build surface 16 and each successive layer, which cools and solidifies, fusing to the previous layer. For example, in the illustrated embodiment, printhead 12 is an extruder head. In other embodiments, system 10 and printhead 12 may be or include one or more other forms of additive manufacturing systems, for example and without limitation, a material jetting system; a binder jetting system; a sheet lamination system; a vat photo polymerization system; a powder bed fusion system such as selective laser sintering, selective laser melting or electron beam melting; and/or a direct energy deposition system, e.g., a laser engineered net shaping system. Thus, in the various embodiments, printhead 12 may be operative to discharge a material and/or energy to generate layers of fused material, each layer being fused to a previously printed and fused layer, wherein the fused layers ultimately form all or part of the manufactured article.

In the illustrated embodiment of FIG. 1, additive manufacturing system 10 further includes a printhead carrier 18, a carrier guide rail 20, a pair of vertical risers 22, a printhead rotational joint 24, a printhead rotational joint 26, an X-axis drive module 28, a Y-axis drive module 30, a Z-axis drive module 32 for each riser 22, a rotational drive module 34, a rotational drive module 36 and a controller 38. Printhead 12 is mounted on printhead carrier 18. Printhead carrier 18 is operative to support printhead 12 and ancillary equipment, e.g., build material supplies or supply train, and power and control lines, during translation printhead 12 along the X-axis. Carrier guide rail 20 defines the X-axis. Carrier guide rail 20 supports printhead carrier 18 and guides printhead carrier 18 along the X-axis. X-axis drive module 28 is coupled to printhead carrier 18 and/or carrier guide rail 20, and supplies translational motive power and mechanical position control along the X-axis to printhead carrier 18 and hence, printhead 12. Vertical risers 22 define the Z-axis. Vertical risers 22 support bed 14 and guide bed 14 along the Z-axis. Z-axis drive modules 32 are coupled to vertical risers 22 and/or to bed 14, and supply translational motive power and mechanical position control along the Z-axis to bed 14, and hence build surface 16. Vertical risers 22 and bed 14 jointly define the Y-axis, and guide bed 14 along the Y-axis. Y-axis drive module 30 is coupled to vertical risers 22 and/or to bed 14, and supplies translational motive power and mechanical position control to bed 14 along the Y-axis, and hence to build surface 16. Some embodiments may include two Y-axis drive modules for supplying translational motive power and mechanical position control to bed 14 along the Y-axis.

In one form, printhead rotational joint 24 is operative to rotate printhead 12 about an Rx axis parallel to the X-axis. In other embodiments, printhead rotational joint 24 may be operative to rotate printhead 12 about another axis. Rotational drive module 34 is operative to supply motive power and mechanical position control of printhead rotational joint 24. In one form, printhead rotational joint 26 is operative to rotate printhead 12 about an Ry axis parallel to the Y-axis. In other embodiments, printhead rotational joint 26 may be operative to rotate printhead 12 about another axis. Rotational drive module 36 is operative to supply motive power and mechanical position control of printhead rotational joint 26.

Controller 38 is communicatively coupled to printhead 12, X-axis drive module 28, Y-axis drive module 30, each Z-axis drive module 32, rotational drive module 34, and rotational drive module 36. Controller 38 is operative to execute program instructions stored in a memory 40 (e.g., a computer RAM or ROM memory, mass storage device such as a hard drive or flash memory and/or other type of memory or storage device) communicatively coupled to and accessible to controller 38 to control the output of printhead 12, and to control the operation of X-axis drive module 28, Y-axis drive module 30, each Z-axis drive module 32, rotational drive module 34, and rotational drive module 36 to perform 3-D printing operations. For example, controller 38 is operative to translate printhead 12 to a desired delta-Z between printhead 12 and bed 14, another build surface 16 or a previously printed layer, and to trace a desired pattern in the X-Y plane to build an article layer by layer using an additive manufacturing process. In some embodiments, for example, wherein a separate part, e.g., a previously made or premade part or another part has been assembled to or built into or onto a partially completed 3-D printed article, controller 38 is operative to control rotational drive module 34 and rotational drive module 36, as well as X-axis drive module 28, Y-axis drive module 30, and each Z-axis drive module 32 to print around the part and complete the printing of the article, which in some embodiments may include partially or completely encapsulating the part with the balance of the article being printed.

A non-limiting example of an embodiment of system 10 in the form of a material extrusion system may be obtained by modifying a MakerGear M2 3-D printing system to include printhead rotational joint 24, printhead rotational joint 26, rotational drive module 34 and rotational drive module 36, and modifying its controller and/or operating software to control the rotation of its printhead using rotational joint 24, rotational joint 26, rotational drive module 34 and rotational drive module 36. MakerGear M2 is commercially available from MakerGear, LLC of Beachwood, Ohio, USA.

In some manufacturing scenarios, it is desirable to manufacture an article by initiating an additive manufacturing process, e.g., 3-D printing, and then performing one or more other procedures or operations on the article, for example and without limitation, assembling another part to the article, e.g., placing a premade part on or in the partially formed article at a desired location, and then completing the additive manufacturing process, e.g., to complete the manufacture of the article. Accordingly, embodiments of the present invention include initiating the additive manufacturing of the article on bed 14 associated with additive manufacturing system 10 using an additive manufacturing process; forming a portion of the article using the additive manufacturing process; pausing the additive manufacturing process prior to completion of the article; and performing one or more procedures on the portion of the article.

In some embodiments, the procedure(s) may not include an additive manufacturing process performed using additive manufacturing system 10, but may include an additive manufacturing process performed on another machine or system. In some embodiments, the procedure(s) may not include an additive manufacturing process at all. In some embodiments, the procedure(s) may be or include the assembly of a part, e.g., a premade part, to the portion of the article, e.g., the placement of the part onto or into the portion of the article at a desired location or into an opening or recess in the portion of the article, or may include adhering or affixing the premade part to the portion of the article. In some embodiments, the placement of the part may also include machining the portion of the article to accept locating features, e.g., pins or other locating features that may or may not be a part of the premade part, which are used to locate the part relative to the portion of the article. In other embodiments, other procedures may be performed, e.g., manufacturing or other operations or procedures. After performing the procedure, the additive manufacturing process of the article is resumed. The method then includes completing the additive manufacturing process of the article; and removing the article from the bed 14.

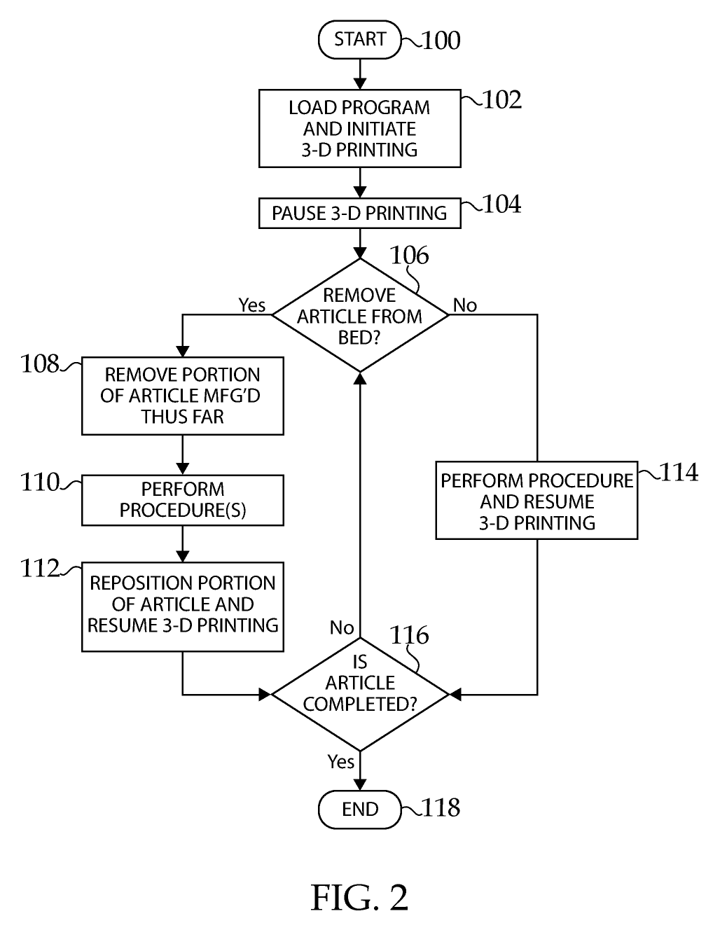

Referring to FIG. 2, some aspects of a non-limiting example of a flowchart depicting a method for manufacturing the article in accordance with an embodiment of the present invention is illustrated. At a block 100, process flow begins. At a block 102, a 3D printing program is loaded into memory 40; additive manufacturing or 3-D printing of an article 42 is initiated on build surface 16, e.g., bed 14 or another surface mounted on bed 14; and 3-D printing is performed to form a portion of article 42. For example, article 42 may be partially formed by 3-D printing to achieve a desired height and/or desired geometric features, following which it is desirable to perform a procedure on the portion of article 42 thus formed. In one non-limiting example, an opening or other feature may be formed onto or into which it is desired to assemble a part, e.g., a premade part, or on which it is desired to perform some other procedure.

At block 104, the additive manufacturing process is paused, e.g., so that the procedure may be performed on the portion of article 42 formed thus far. At block 106, a determination is made as to whether the portion of article 42 manufactured thus far should be removed from bed 16 to perform the procedure. If it is desired that the portion of article 42 be removed from bed 14 in order to perform the procedure, process flow proceeds to block 108, otherwise, process flow proceeds to block 114.

At block 108, the portion of article 42 manufactured thus far is removed from bed 14. In embodiments wherein bed 14 is the build surface 16, the portion of article 14 manufactured thus far is removed from the build surface 16. In some embodiments, the portion of article 42 is printed onto a build surface 16 that is itself mounted onto bed 14, in which case at block 108, the build surface 16 is removed from bed 14. In various embodiments, the portion of the article 42 may be removed robotically or manually.

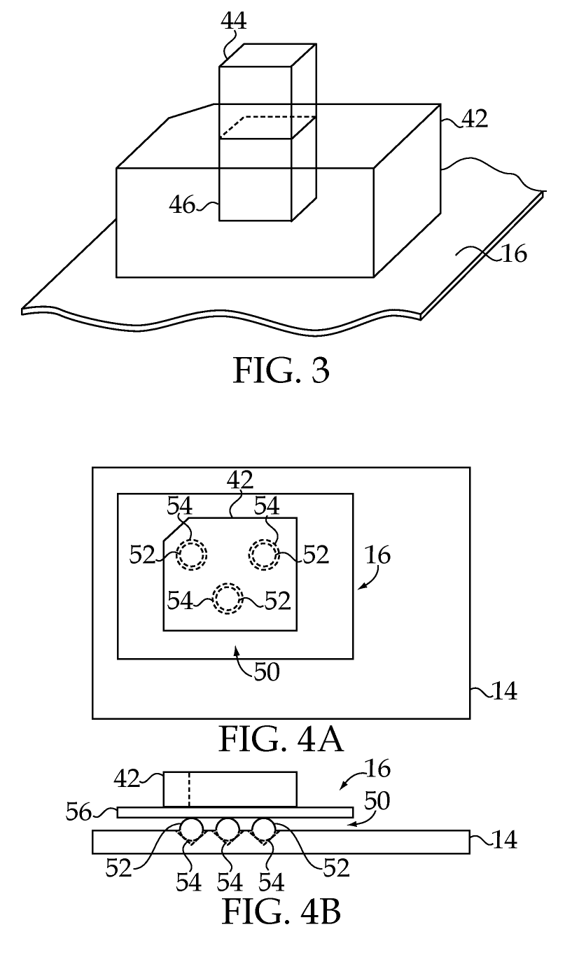

At block 110, one or more procedures are performed, which in some embodiments may include placing the portion of article 42 into another machine or system in order to perform the procedure. As set forth above, procedures may be, for example, the assembly of one or more parts to the portion of article 42, e.g., premade parts, 3-D printing of a part on article 42 using system 10 or another additive manufacturing system, one or more machining or other manufacturing processes, or any manufacturing, inspection and/or any other procedure. In the illustration of FIG. 3, the procedure is the assembly of a premade part 44 to the portion of article 42 manufactured thus far. For example, in some embodiments, the portion of article 42 manufactured thus far includes a square opening 46 into which a rectangular premade part 44 is inserted. In various embodiments, part 44 may be assembled to the portion of article 42 robotically or manually.

At block 112, the portion of article 42 manufactured thus far is replaced or repositioned onto bed 14 after the procedure is performed, and the additive manufacturing or 3-D printing of article 42 is resumed. In one form, the repositioning includes replacing the portion of article 42 manufactured thus far onto bed 14 and repositioning the portion of article 42 at the original location on bed 14 in which the portion of article 42 was disposed prior to being removed at block 108. For example, the portion of article 14 is repositioned to the same Z, Y and Z coordinates in which it was disposed prior to removal at block 108. By accurately repositioning the portion of article 42 after performing one or more procedures, and in some embodiments geometrically constraining all or most degrees of freedom of the repositioned portion of article 42 after performing one or more procedures, the additive manufacturing process may be continued without adversely impacting the quality of the additively manufactured article 42, without substantially adversely impacting the quality of the additively manufactured article 42, or with minimal adverse impact, depending upon the embodiment. For example, without accurate repositioning, small gaps or flaws in the 3-D printed structure of article 42 may be formed after 3-D printing is resumed. The repositioning may be performed robotically or by human hand, alone or with the use of tools.

In some embodiments, the repositioning includes the use of a part positioning feature. For example, referring to FIGS. 4A and 4B, some aspects of a non-limiting example of a respective schematic plan view and side view of a portion of system 10 are illustrated. FIGS. 4A and 4B illustrate the portion of article 42 with part 44 and opening 46 not shown for the sake of clarity. In the example of FIGS. 4A and 4B, a repositioning feature 50 in the form of a kinetic ball mount is employed. Repositioning feature 50 includes three kinetic balls 52 disposed in conical openings 54. Conical openings 54 are disposed in bed 14 in a triangular pattern. In one form, the kinetic balls are ½ inch spheres. In other embodiments, other sizes of kinetic balls may be employed. In other embodiments other number of kinetic balls may be used, other shapes for openings 54 may be used, and other geometric spacing patterns of kinetic balls 52 and conical openings 54 may be employed. Kinetic balls 52 are affixed to a plate 56 which functions as build surface 16 in the embodiment of FIGS. 4A and 4B, onto which article 42 is additively manufactured. For example, kinetic balls 52 may be adhered to plate 56 with an adhesive. In other embodiments, other forms of kinetic ball mounts may be employed.

In embodiments employing kinetic ball mounts, portion of article 42 is removed from and subsequently repositioned on bed 14 simply by lifting plate 56 off of bed 14 to remove portion of article 42, and then matching kinetic balls 52 with corresponding conical openings 54 and replacing plate 56 onto bed 54, engaging kinetic balls 52 with corresponding conical openings 54, to reposition the portion of article 42 on bed 14. In some embodiments, as an alternative to using plate 56, the printing of article 42 may be performed directly onto bed 14, and may include rotation of printhead 12 about one or both of rotational joints 24 and 26 during the printing process to thereby partially encapsulate kinetic balls 52. In such embodiments, portion of article 42 is removed from and repositioned on bed 14 simply by lifting and removing it from bed 14, and by subsequently matching kinetic balls 52 with corresponding conical openings 54 and replacing the portion of article 42 back onto bed 14 while engaging kinetic balls 52 with conical openings 54, respectively. Kinetic balls 52 may be machined to high precision and accuracy in order to improve the accuracy of replacement or repositioning, e.g., +/−0.000001 inch in some embodiments.

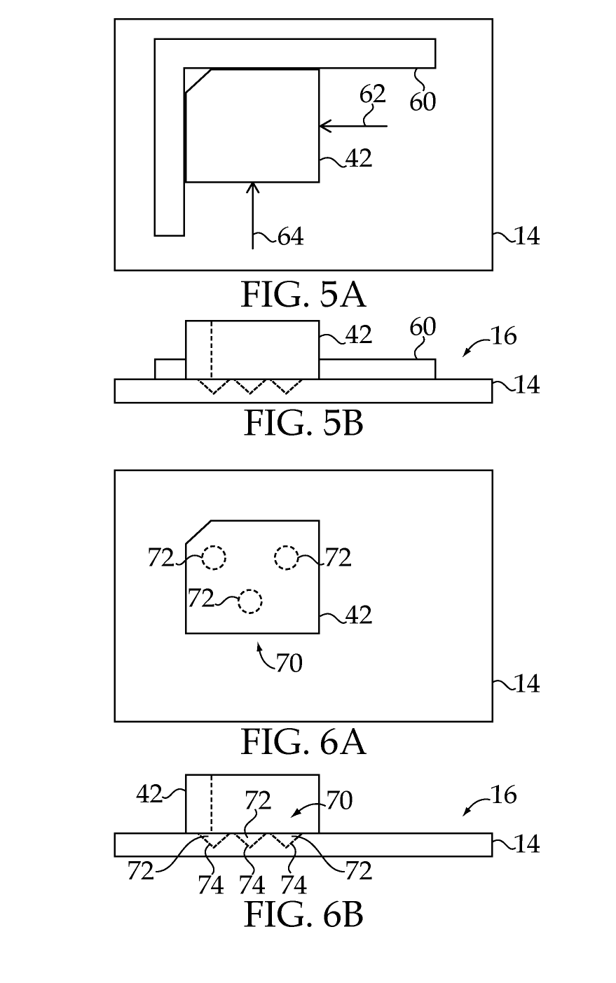

Referring to FIGS. 5A and 5B some aspects of a non-limiting example of a respective schematic plan view and side view of a portion of system 10 with a repositioning feature in the form of a block, e.g., a corner block, are schematically illustrated. FIGS. 5A and 5B illustrate the portion of article 42 with part 44 and opening 46 not shown for the sake of clarity. In the embodiment of FIGS. 5A and 5B, a corner block may be used to reposition the portion of article 42 manufactured thus far. For example, prior to removal of the portion of article 42 from bed 14, a repositioning feature 60 in the form of a corner block may be placed against, e.g., pushed into pushed into position against, two edges or other portions of article 42 and clamped or otherwise fixed in place. In other embodiments, one or more of other forms of blocks may be used. The portion of article 42 may then be removed, and the procedure performed. The portion of article 42 may then be placed back onto bed 42 in close proximity to repositioning feature 60. Pushing forces 62 and 64 may then be applied to the portion of article 42 in the direction of repositioning feature 60 to direct it against repositioning feature 60. Gravity, clamping features (e.g., features formed as a part of or as temporarily a part of article 42 that may be clamped to bed 14 to secure the portion of article 42) or adhesive force may then be employed to retain the portion of article 42 as repositioned back in the original printing location. In some embodiments, an adhesive may be employed to secure the portion of article 42 to bed 14. Although a 90 degree corner block is illustrated in FIGS. 5A and 5B, it will be understood that any suitable shape that aligns with desired surfaces, lines or points on the portion of the article 42 may be employed.

Referring to FIGS. 6A and 6B, some aspects of a non-limiting example of a respective schematic plan view and side view of a portion of system 10 with repositioning features 70 in the form of pins are schematically illustrated. FIGS. 6A and 6B illustrate the portion of article 42 with part 44 and opening 46 not shown for the sake of clarity. In the embodiment of FIGS. 6A and 6B, pins 72, i.e., protuberances extending from the portion of article 42 manufactured thus far, may be used to reposition the portion of article 42 manufactured thus far. For example, pins 72 may be engaged with openings 74 disposed in bed 14. In the example of FIGS. 6A and 6B, three (3) pins 72 having a conical shape are disposed in corresponding conically shaped openings 74. The pins 72 and openings 74 are disposed in a triangular pattern. In other embodiments, pins 72 and openings 74 may have other geometric shapes, and any number of pins 72 and corresponding openings 74 arranged in any suitable geometric spacing configuration may be employed. In one form, pins 72 are additively manufactured into openings 74, e.g., 3-D printed by printhead 12. In other embodiments, separate standalone pins may be employed, e.g., inserted into openings 74, wherein printhead 12 prints around the pins, e.g., to adhere the subsequently printed article 42 to the pins or to or to partially encapsulate the pins within article 42. In embodiments employing pins 72 with openings 74, the portion of article 42 is removed from and repositioned on bed 14 simply by lifting it off of bed 14, and subsequently replacing it onto bed 54 while engaging pins 72 with openings 74, respectively. In some embodiments, pins 72 may be adhered to or otherwise affixed to or formed as part of a separate plate, e.g., such as plate 56, which may function as a build surface 16 onto which article 42 is built.

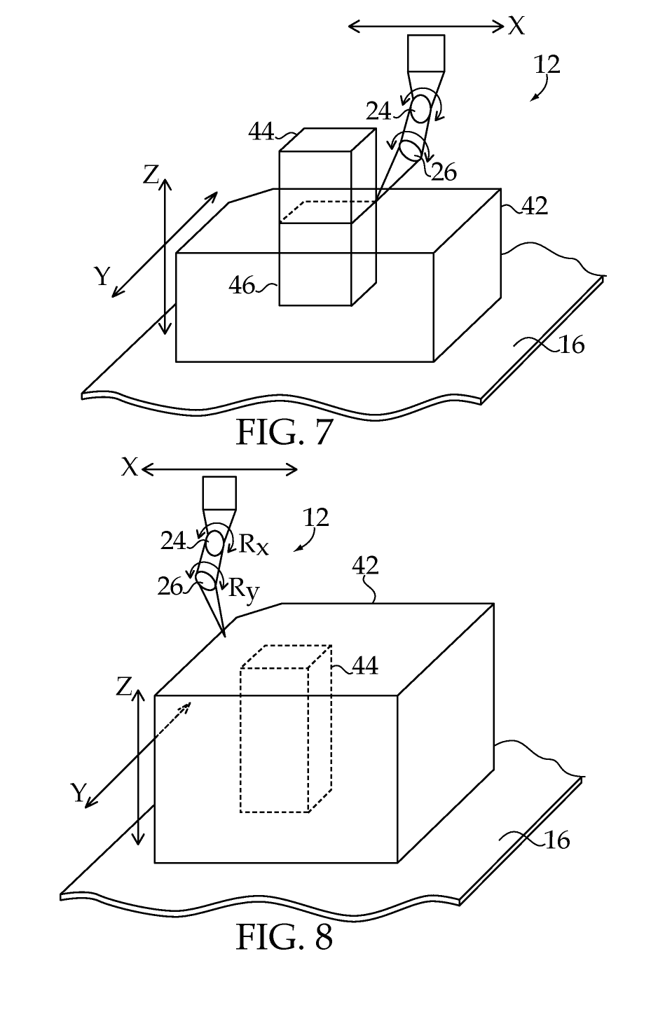

After the portion of article 42 is repositioned at the original location on bed 14, the 3-D printing of article 42 is continued until either article 42 is completed or until a point is reached at which it is desired to perform another procedure, such as described above with respect to block 110, in which case printing is paused upon reaching that point. Referring to FIG. 7, in some embodiments, the additive manufacturing or 3-D printing includes manipulating or varying the orientation of printhead 12 by rotating it about rotational joint 24 and/or rotational joint 26 in order to perform 3-D printing that includes printing around all or a portion of part 44. For example, the rotation of printhead 12 allows printing at the intersection of part 44 and the previously printed topmost layer of the portion of article 42 manufactured thus far, and printing in close proximity to part 44 that may not be otherwise achievable absent the rotation. In some embodiments, the rotation may take place during translation the X, Y and/or Z directions, including during printing, whereas in other embodiments, the rotation may take place before printing or between printing passes.

By rotating printhead 12 about rotational joint 24 and/or rotational joint 26, printhead 12 may be oriented so as to be able 3-D print around the periphery of part 44 that may not be otherwise achievable absent the rotation about rotational joint 24 and/or rotational joint 26. In some embodiments, the continued 3-D printing at block 112 includes partially or completely encapsulating the assembled part 44. For example, in the depiction of FIG. 8, part 44 has been completely encapsulated by article 42 by 3-D printing article 42 around and over part 44. In some embodiments, the rotation of printhead 12 about rotational joints 24 and/or 26 allows 3-D printing in planes out of the initial printing plane, e.g., the X-Y plane. For example, selective translation in the X, Y and Z axes with printhead 12 rotated to a desired angle may allow printing in any or almost any plane at any or almost any angle relative to the initial printing plane or the basic printing plane, e.g., the X-Y plane.

After the 3-D printing of article 42 is completed or the point is reached at which it is desired to perform another procedure, process flow proceeds to block 16.

Alternatively to blocks 108, 110 and 112, if the determination at block 106 was that the portion of article 42 did not need to be removed from system 10 in order to perform the procedure, process flow proceeds to block 114. At block 114, the procedure is performed, e.g., as described above, but without removing the portion of article 42 from system 10; and 3-D printing of article 42 is resumed, e.g., as described above, until the 3-D printing of article 42 is completed or the point is reached at which it is desired to perform another procedure, e.g., as described above. Process flow then proceeds to block 116.

At block 116, a determination is made as to whether article 42 is completed or whether any additional procedures are to be performed. For example, whereas in some embodiments the 3-D printing may be completed in its entirety at this stage, in other embodiments, one or more additional procedures (e.g., as described above with respect to blocks 110 and/or 114) and subsequent stages of 3-D printing may be performed. If article 42 is completed, process flow proceeds to block 118. At block 118, process flow ends. If one or more additional procedures are to be performed, process flow proceeds back to block 106. In the non-limiting example of FIG. 8, the completed article 42 includes the encapsulated premade part 44.

Embodiments of the present invention include a method for manufacturing an article, comprising: initiating an additive manufacturing of the article on a bed associated with an additive manufacturing system using an additive manufacturing process; forming a portion of the article using the additive manufacturing process; pausing the additive manufacturing process prior to completion of the article; performing a procedure on the portion of the article, wherein the procedure is not an additive manufacturing process performed using the additive manufacturing system; after performing the procedure, resuming the additive manufacturing process of the article; completing the additive manufacturing process of the article; and removing the article from the bed.

In a refinement, the performing of the procedure on the portion of the article includes assembling a premade part to the portion of the article.

In another refinement, the resuming of the additive manufacturing process of the article includes 3-D printing the article at least partially around the part.

In yet another refinement, the 3-D printing includes rotating a printhead of the additive manufacturing system about at least two axes.

In still another refinement, the method further comprises 3-D printing the article to at least partially encapsulate the part.

In yet still another refinement, the method further comprises 3-D printing the article to encapsulate the part.

In a further refinement, the method further comprises removing the portion of the article from the bed after pausing the additive manufacturing process and before performing the procedure; and replacing the portion of the article onto the bed after performing the procedure.

In a yet further refinement, the portion of the article is positioned at an original location on the bed prior to removing the portion of the article, wherein the replacing of the portion of the article onto the bed includes repositioning the portion of the article at the original location.

In a still further refinement, the part is repositioned using a positioning feature.

In a yet still further refinement, the positioning feature includes at least one of a block, a corner block; a pin and a kinematic ball.

In another further refinement, the additive manufacturing system includes a printing head operative to rotate about at least two axes; and wherein the additive manufacturing process includes rotating the printing head about the at least two axes.

Embodiments of the present invention include a method for manufacturing an article, comprising: initiating the additive manufacturing of the article on a bed associated with an additive manufacturing system using an additive manufacturing process; forming a portion of the article using the additive manufacturing process; pausing the additive manufacturing process prior to completion of the article; removing the portion of the article from a location on the bed; assembling a premade part to the portion of the article; repositioning the portion of the article to the location on the bed; resuming the additive manufacturing process to complete the article; and removing the article from the bed.

In a refinement, the resuming the additive manufacturing process includes 3-D printing the article at least partially around the part.

In another refinement, the method further comprises rotating a printhead of the additive manufacturing system about at least one axis before or during the 3-D printing.

In yet another refinement, the method further comprises using a positioning feature to perform the repositioning of the portion of the article

In still another refinement, the method further comprises applying a force to the portion of the article in the direction of the positioning feature.

In yet still another refinement, the positioning feature includes at least one of a corner block; a pin and a kinematic ball.

Embodiments of the present invention include a system for performing additive manufacturing of an article on a build surface, comprising: a printhead operative to discharge material and/or energy to generate successive fused layers on the build surface; a first drive module operative to generate relative translational motion between the printhead and the build surface along a first axis; a second drive module operative to generate relative translational motion between the printhead and the build surface along a second axis orthogonal to the first axis; a third drive module operative to generate relative translational motion between the printhead and the build surface along a third axis orthogonal to the first axis and to the second axis; and a rotational joint operative to rotate the printhead about a fourth axis.

In a refinement, the system further comprises another rotational joint operative to rotate the printhead about a fifth axis.

In another refinement, the fourth axis is parallel to the first axis; and wherein the fifth axis is parallel to the second axis.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. A method for manufacturing an article, comprising:
initiating an additive manufacturing of the article on a bed associated with an additive manufacturing system using an additive manufacturing process;
forming a portion of the article using the additive manufacturing process;
pausing the additive manufacturing process prior to completion of the article;
performing a procedure on the portion of the article, wherein the procedure is not an additive manufacturing process performed using the additive manufacturing system;
after performing the procedure, resuming the additive manufacturing process of the article;
completing the additive manufacturing process of the article; and
removing the article from the bed.

2. The method of claim 1, wherein the performing of the procedure on the portion of the article includes assembling a premade part to the portion of the article.

3. The method of claim 2, wherein the resuming of the additive manufacturing process of the article includes 3-D printing the article at least partially around the part.

4. The method of claim 3, wherein the 3-D printing includes rotating a printhead of the additive manufacturing system about at least two axes.

5. The method of claim 3, further comprising 3-D printing the article to at least partially encapsulate the part.

6. The method of claim 3, further comprising 3-D printing the article to encapsulate the part.

7. The method of claim 1, further comprising removing the portion of the article from the bed after pausing the additive manufacturing process and before performing the procedure; and replacing the portion of the article onto the bed after performing the procedure.

8. The method of claim 7, wherein the portion of the article is positioned at an original location on the bed prior to removing the portion of the article, wherein the replacing of the portion of the article onto the bed includes repositioning the portion of the article at the original location.

9. The method of claim 8, wherein the part is repositioned using a positioning feature.

10. The method of claim 9, wherein the positioning feature includes at least one of a block, a corner block; a pin and a kinematic ball.

11. The method of claim 1, wherein the additive manufacturing system includes a printing head operative to rotate about at least two axes; and wherein the additive manufacturing process includes rotating the printing head about the at least two axes.

12. A method for manufacturing an article, comprising:
initiating the additive manufacturing of the article on a bed associated with an additive manufacturing system using an additive manufacturing process;
forming a portion of the article using the additive manufacturing process;
pausing the additive manufacturing process prior to completion of the article;
removing the portion of the article from a location on the bed;
assembling a premade part to the portion of the article;
repositioning the portion of the article to the location on the bed;
resuming the additive manufacturing process to complete the article; and
removing the article from the bed.

13. The method of claim 12, wherein the resuming the additive manufacturing process includes 3-D printing the article at least partially around the part.

14. The method of claim 13, further comprising rotating a printhead of the additive manufacturing system about at least one axis before or during the 3-D printing.

15. The method of claim 12, further comprising using a positioning feature to perform the repositioning of the portion of the article

16. The method of claim 15, further comprising applying a force to the portion of the article in the direction of the positioning feature.

17. The method of claim 16, wherein the positioning feature includes at least one of a corner block; a pin and a kinematic ball.

18. A system for performing additive manufacturing of an article on a build surface, comprising:
a printhead operative to discharge material and/or energy to generate successive fused layers on the build surface;
a first drive module operative to generate relative translational motion between the printhead and the build surface along a first axis;
a second drive module operative to generate relative translational motion between the printhead and the build surface along a second axis orthogonal to the first axis;
a third drive module operative to generate relative translational motion between the printhead and the build surface along a third axis orthogonal to the first axis and to the second axis; and
a rotational joint operative to rotate the printhead about a fourth axis.

19. The system of claim 18, further comprising another rotational joint operative to rotate the printhead about a fifth axis.

20. The system of claim 19, wherein the fourth axis is parallel to the first axis; and wherein the fifth axis is parallel to the second axis.
